(19) United States
(12) Patent Application Publication
(10) Pub. No.: US 2004/0205076 A1
(43) Pub. Date: Oct. 14, 2004

(54) System and method to automate the management of hypertext link information in a Web site

(75) Inventors: Anita Wai-Ling Huang, San Francisco, CA (US); Neelakantan Sundaresan, San Jose, CA (US)

Correspondence Address: MORGAN & FINNEGAN, L.L.P., 345 Park Avenue, New York, NY, 10154-0053, US

(73) Assignee: International Business Machines Corporation

(21) Appl. No.: 10/785,184

(22) Filed: Feb. 25, 2004

Related U.S. Application Data
(63) Continuation of application No. 09/799,024, filed on Mar. 6, 2001, now abandoned.

(51) Int. Cl. G06F 17/00

(52) U.S. Cl. 707/100; 709/224

(57) ABSTRACT

A Web site management system uses a Web-crawler to traverse (i.e., crawl) Web sites on the Internet. The Web-crawler identifies the Web pages accessible from each Web site and uses the hypertext link information embedded in those Web pages to discern relationships between the various Web pages. A change-detection and notification system analyzes the results from the Web-crawler to determine whether a specific hypertext link is erroneous. The change-detection and notification system creates an electronic mail message that includes a description of the actions that may correct the erroneous hypertext link, a recommended action, and an attachment to the electronic mail message that comprises a copy of the Web page after applying the recommended action. If a subscriber registered the author of the Web page that contains the erroneous link with the present invention, the change-detection and notification system sends the electronic mail message to the author. If the author of the Web page is unknown, the change-detection and notification system applies heuristic algorithms and performs a probabilistic analysis to deduce an electronic mail address that will likely contact either the author or a person responsible for managing the Web site that hosts the Web page.

### FIELD OF THE INVENTION

This disclosure relates to a network change-detection system, method, and computer program product. More particularly, this disclosure relates to a system, method, and computer program product that automates the management of hypertext link information embedded in Web site digital resources.

### BACKGROUND OF THE INVENTION

The Internet is a collection of networks connected by routers. These routers use network protocols such as the Transmission Control Protocol/Internet Protocol (“TCP/IP”) to transfer digital information between host computers on the network. The Internet is the backbone architecture that makes it possible for people, throughout the world, to communicate in a fast and affordable manner.

The World Wide Web (“Web”) is a system of server computers on the Internet that support the standards defining both the structure of a Web page and the protocol for passing information between a client and server computer. A Web page author uses a Structured Generalized Markup Language (“SGML”), such as HyperText Markup Language (“HTML”) or Extensible Markup Language (“XML”), to structure the presentation of the text, graphics, audio, and video content of a Web page. The textual content of a Web page includes hypertext links embedded in the text to allow the reader to click on the hypertext link in the document text to quickly access another, related, resource on the Web. In addition, the Web page author can use a software development environment and programming language such as JavaScript or Java to create and modify programs called from the Web page HTML code. The Web page author first creates or modifies a Web page and then publishes the Web page on a Web site to make it accessible to other Web users. Additional discussion of Web publishing is provided in the book by William Robert Stanek et al., entitled “Web Publishing Unleashed: HTML, Java, CGI, VRML, SGML”, published by Sams.Net, March 1996.

The Web and HTML make it relatively easy for a Web page author to create and update a Web page. This ease not only promotes the proliferation of information on the Web, but also increases the chance that a Web page author may improperly alter a hypertext link in a Web page. In addition, a Web page author cannot guarantee that a Web resource referenced by the Web page is correct and still accessible via the hypertext link. A Web page that contains out-of-date links is useless to the Web page user and causes the user to either continue examining other links in the search result set, perform a new search, or abandon the search altogether. To a user of the Web, the Web page content and the accuracy of the embedded hypertext links determine the reliability of both the Web page and the hosting Web site.

Proper management of a Web site demands periodic testing of every Web page associated with the site by following every link on the page to test the validity and reliability of the link. The responsibility for this testing falls upon a Web site manager. The Web site manager typically determines the frequency of the link testing (e.g., once a month), but relies upon either the Web page author, or someone hired by the author, to update the content, examine the hypertext links, and correct any errors. Since this testing requires a considerable amount of time, the cost to assure that a Web site's links are up-to-date will increase in proportion to the number of links available on the Web site. In addition, the manual nature of the link checking process described above is highly prone to error.

Web site management systems exist that can detect a change to the content of a Web page, including the embedded hypertext links, and can notify the user of the software of a possible error in the Web page. These management systems rely, however, on the software user to decide whether the change to the Web page warrants correction. The usefulness of this type of system depends on the algorithm used to detect a change to a Web page. Previous versions of these systems used a checksum algorithm to detect changes to a Web page. The checksum approach can accurately detect a change to the textual content, but cannot determine the severity of the change. As such, the checksum approach will notify the user that a Web page may not be up-to-date whether the change is substantial (e.g., the link to a document changed) or insubstantial (e.g., correction of a spelling or grammer error). Since the checksum approach notifies the user of every change to the content, the inability of these systems to distinguish between a major and a minor change unduly burdens the user and makes the process more prone to error.

Though the number of accessible Web sites will continue to increase as the Web becomes more popular, a similar increase in the possibility of entanglement among active (i.e., accessible) and inactive (i.e., inaccessible) Web pages will likely result. Entanglement becomes more likely when the Web site manager's ability to keep the hypertext links in a Web site up-to-date exceeds the ability of the Web site management software. The reliance that previous Web site management systems place on a human to maintain up-to-date hypertext links limit the speed, growth, and efficiency of the Web. An automated Web site management system, on the other hand, would decrease the time required for a Web site manager to test the links in a Web site and improve the quality of the Web pages on the site. This system would increase the efficiency of the people searching the Web, as well as the accuracy of the content and the reliability of the Web sites.

The present invention is an automated Web site management system that addresses the problems described above with the management of hypertext link information in a Web site. A Web site management system that increases the accuracy of the hypertext link information in a Web page will increase the reliability of the Web site and improve the efficiency of the users on the Web. This system must identify all of the Web pages that relate to a particular Web page, determine the status of the linked Web pages, report the status and any errors to the appropriate Web page author, and provide a reasonable suggestion to correct any erroneous links. When the system performs these functions in an automated and proactive fashion, the system will reduce the time required for Web page authors to check the status of the Web pages and correct any errors.

### SUMMARY OF THE INVENTION

The present invention is a system, method, and computer program product that automates the management of link information for a Web site connected to a network. The system analyzes a Web site on the Internet, collects Web site hypertext link information embedded in the Web site digital resources, and notifies the author of the digital resource when a hypertext link in the digital resource is either not accessible or erroneous.

A subscriber to the present invention uses the registration system or module of the present invention to create and maintain associations in a database between a uniform resource locator (“URL”) and a Web author. When a hypertext link in that URL is erroneous or inaccurate, the system will notify the Web page author of the error by electronic mail. The subscriber may use either a graphical user interface in the registration module to enter a single URL and Web page author pair or a bulk load user interface in the registration module to quickly load numerous pairs.

A Web-crawler communicates with a Web site to determine which Web servers are accessible from the site. In addition, the Web-crawler visits the Web sites on a network to index the Web pages accessible on the Web site, to collect hypertext link information that describes the relationship between the Web pages, and to characterize the content associated with the Web site. The Web-crawler communicates this information to a change-detection and notification system for storage in the database. The database structure includes each URL accessible from the Web site, the parent-child relationships between the URLs, the metadata describing the Web site and hypertext links embedded in the Web pages on the Web site, and an electronic mail address for the author of each URL.

The change-detection module attempts to connect to each Web page hypertext link retrieved by the Web-crawler. If the response to the connection request indicates that the connection was not successful, the change-detection module queries the database to determine how to correct the reference to the hypertext link. The change-detection module composes the body of an electronic mail message that includes a description of the actions that may correct the erroneous reference to the hypertext link, a recommended action, and an attachment that contains the reference to the hypertext link after application of the recommended action. If the response to the connection request indicates that the connection was successful, the change-detection module examines the content associated with the Web page hypertext link to determine if the content has changed.

For each Web page that contains an erroneous reference to a hypertext link, the notification module determines whether the database associates an author with the Web page that contains the erroneous reference to a hypertext link. If an association exists in the database, the notification module sends an electronic mail message to the Web page author that includes the body of the electronic mail message composed by the change-detection module. If an association does not exist in the database, the notification module applies heuristic algorithms and performs a probabilistic analysis to deduce an electronic mail address that is likely to contact either the author of the Web page or someone who manages the Web site associated with the Web page.

### BRIEF DESCRIPTION OF THE DRAWINGS

The accompanying figures best illustrate the details of the present invention, both as to its structure and operation. Like reference numbers and designations in these figures refer to like elements.

FIG. 1 is a network diagram depicting an operating environment for the preferred embodiment of a change-detection and notification system according to the present invention.

FIG. 2 depicts the network diagram of FIG. 1 showing the relationship between the elements that comprise the change-detection and notification system and the operating environment.

FIG. 3 illustrates an example of a database structure that the change-detection and notification system may use.

FIG. 4 is a functional block diagram of the change-detection and notification system that shows the configuration of the hardware and software components.

FIG. 5A is a flow diagram of a process in the change-detection and notification system that detects a change to a Web page on a network.

FIG. 5B is a flow diagram of an element in FIG. 5A that notifies a Web page author when a Web page contains an erroneous hypertext link.

### DETAILED DESCRIPTION OF THE INVENTION

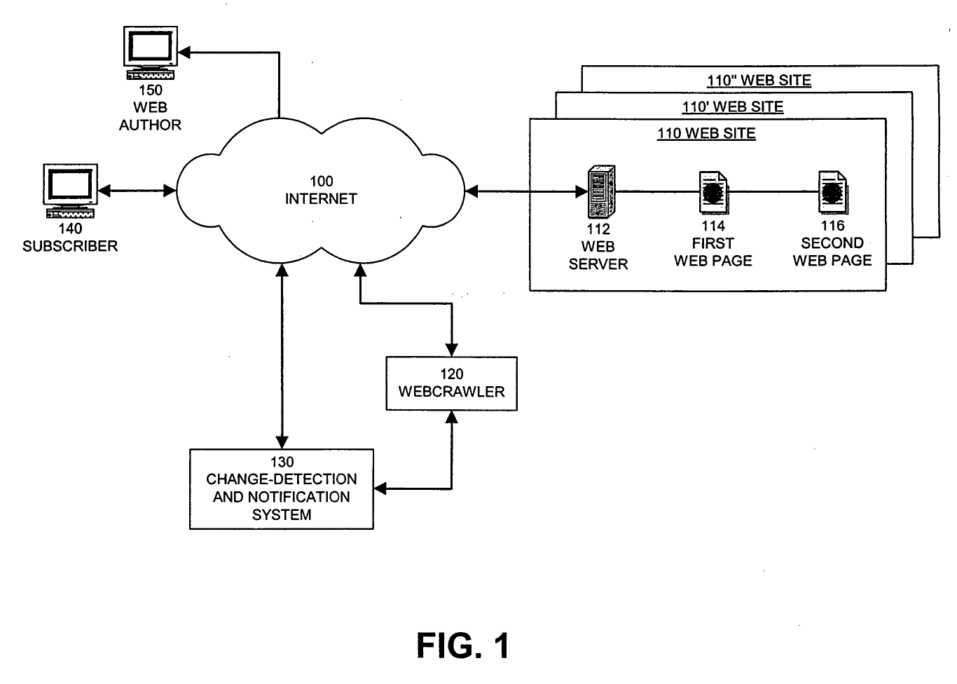

FIG. 1 depicts the operating environment for the preferred embodiment of a change-detection and notification system. The operating environment comprises the Internet 100, Web site 110, Web-crawler 120, change-detection and notification system 130, subscriber 140, and Web author 150. In addition, the Web site 110 includes a Web server 112, first Web page 114, and second Web page 116 configured so that the Web server 112 can access the first Web page 114 which contains a hypertext link to the second Web page 116. The preferred embodiment of the present invention analyzes the Web site 110 on the Internet 100, collects metadata describing the Web server 112, first Web page 114, and second Web page 116, and notifies a Web author 150 when the hypertext link to the second Web page 116 is disparate, dissimilar, or erroneous. This invention improves the efficiency of users browsing the Internet 100 by making the link information embedded in the digital resources more reliable and accurate.

As shown in FIG. 1, the Internet 100 is a public communication network that allows the Web-crawler 120 and change-detection and notification system 130 to communicate with a Web site 110, subscriber 140, and Web author 150. Even though the preferred embodiment uses the Internet 100, the present invention contemplates the use of other public or private network architectures such as an intranet or extranet. An intranet is a private communication network that functions similar to the Internet 100. An organization, such as a corporation, creates an intranet to provide a secure means for members of the organization to access the resources on the organization's network. An extranet is also a private communication network that functions similar to the Internet 100. In contrast to an intranet, an extranet provides a secure means for the organization to authorize non-members of the organization to access certain resources on the organization's network. The present invention also contemplates using a network protocol such as Ethernet or Token Ring, as well as proprietary network protocols.

As shown in FIG. 1, the digital resources residing on the Web site 110 are Web pages. While the preferred embodiment uses Web pages and hypertext links, the present invention contemplates the use of a digital resource such as an XML or image file that has a link to another digital resource embedded in the content of the digital resource.

A Web-crawler 120, also known as a spider, ant, robot, bot, or intelligent agent, is a computer program that retrieves information stored on the network 100 based on user-defined search criteria. The Web-crawler 120 communicates with a Web site 110 to determine which Web server 112 is accessible from the Web site 110. The book by Colin Harrison et al., entitled “Agent Sourcebook: A Complete Guide to Desktop, Internet, and Intranet Agents” (John Wiley & Sons, Jan. 15, 1997) provides a cogent discussion of agent technology. The Web server 112 shown in FIG. 1 is a conventional personal computer or computer workstation. Furthermore, Web server 112 includes the proper operating system, hardware, communications protocol (e.g., Transmission Control Protocol/Internet Protocol), and Web server software to host a collection of Web pages such as first Web page 114 and second Web page 116.

For each Web site 110 on the Internet 100, the Web-crawler 120 of the preferred embodiment visits the Web site 110 to index the Web server 112, first Web page 114, and second Web page 116 that are accessible on the Web site 110. The Web-crawler 120 collects metadata that describes the Web server 112, first Web page 114, and second Web page 116, as well as metadata that describes the hypertext link between the first Web page 114 and the second Web page 116. The Web-crawler 120 communicates the information that it collects to the change-detection and notification system 130. A benefit of the present invention is that a single crawl of the Internet 100 by the Web-crawler 120 will generate a comprehensive set of characteristics that describe each Web site 110 and hypertext links in the Internet 100. The present invention can use any commercially available Web-crawler that provides similar functionality to the “Gatherer” component of the Grand Central Station® product by International Business Machines Corporation (“IBM®”). Additional discussion of Grand Central Station® can be found at the IBM® Web site at “http://www.research.ibm.com/topics/popups/smart/network/html/gcs.html” and “http://www.research.ibm.com/resources/magazine/1997/issue_{—}3/grandcentral397.html”.

In the preferred embodiment, the subscriber 140 shown in FIG. 1 is an organization such as a corporation that registers a series of Web pages with the present invention and identifies a Web author 150 responsible for maintaining the content of each Web page. If the change-detection and notification system 130 detects an erroneous hypertext link in one of the registered Web pages, the system will automatically send a message to the Web author 150 responsible for maintaining the Web page.

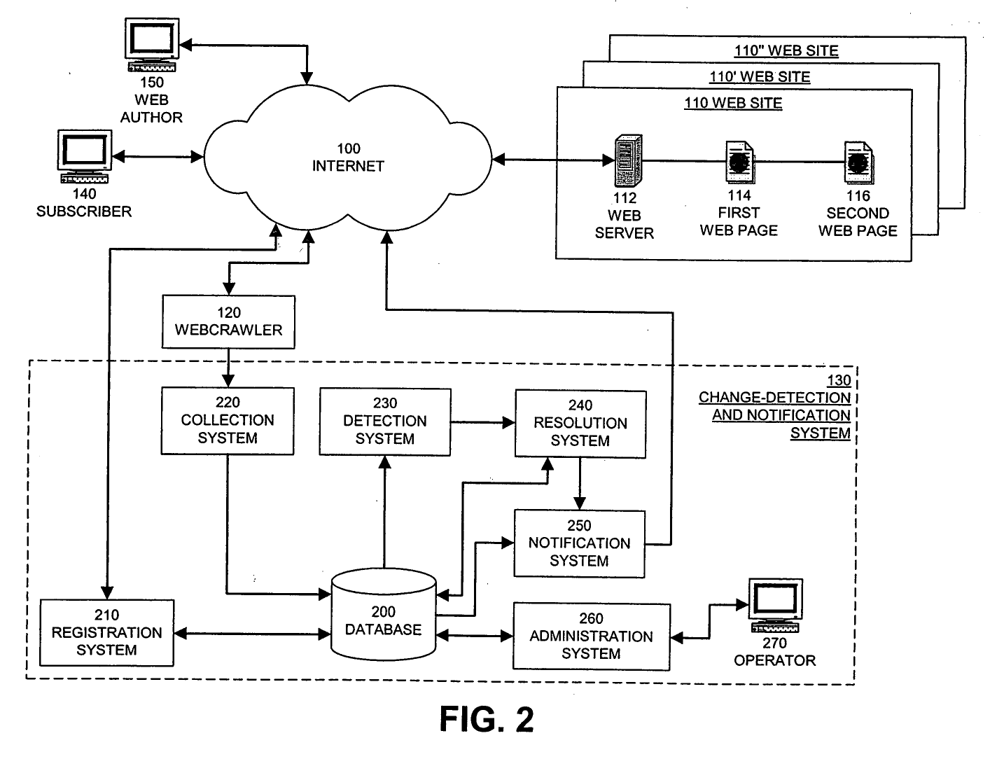

FIG. 2 expands the detail of the change-detection and notification system 130 in FIG. 1 to show the relationship between the elements that comprise the change-detection and notification system 130 and the operating environment. The change-detection and notification system 130 includes graphical user interface and processing components. Even though the preferred embodiment depicts each of these components as software modules in a single computer system, the present invention contemplates the distribution of each component to a distributed computer system on the Internet 100.

The graphical user interface components shown in FIG. 2 include the registration system 210 and the administration system 260. The subscriber 140 accesses the registration system 210 through the Internet 100 to populate the database 200 with a URL and the Web author responsible for maintaining the URL. In addition, the subscriber 140 can use the bulk load feature of the registration system 210 to rapidly insert multiple URL and Web author pairs into the database 200. The operator 270 accesses the administration system 260 using a direct connection to the change-detection and notification system 130 to perform system maintenance and status function for the present invention. While FIG. 2 depicts the operator 270 interface to the administration system 260, the present invention contemplates that the operator 270 connection through the Internet 100.

The processing components shown in FIG. 2 include the collection system 220, detection system 230, resolution system 240, and notification system 250. Periodically, the Web-crawler 120 gleans metadata from a Web site 110 and passes that metadata to the collection system 220 for storage on the database 200. The detection system 230 will periodically examine the database 200 to search for disparities in the metadata gleaned by the Web-crawler 120. In the preferred embodiment, this examination involves an attempt to connect to a URL such as the second Web page 116 because the metadata indicates that the second Web page 116 is the target in the hypertext link in the first Web page 114. If the target in the hypertext link is not accessible, the detection system 230 invokes the resolution system 240 to determine why is second Web page 116 is not accessible.

The resolution system 240 queries the database 200 for similar hypertext links and determines a plethora of solutions that can repair the hypertext link to the second Web page 116. The resolution system indicates a recommended solution and creates a copy of the first Web page 114 that incorporates the recommended solution. The resolution system 240 invokes the notification system 250 to package the solution list, recommended solution, and copy of the first Web page 114 into the body of an electronic mail message. The notification system 250 applies a two-stage process to determine an address for the electronic mail message. In the first stage, the notification system 250 queries the database 200 to find a Web author 150 that is associated with the first Web page 114. If the first stage is successful, the notification system 250 sends the electronic mail message. If the first stage is not successful, the second stage applies heuristic algorithms and performs a probability analysis to deduce the Web author 150 by analyzing the metadata collected by the Web-crawler 120. If the second stage is successful, the notification system 250 updates the database 200 to reflect these findings and sends the electronic mail message. If the second stage is not successful, the notification system 250 updates the database to indicate that the system cannot identify the Web author 150.

An alternative embodiment of the present invention automates the repair of erroneous and inaccessible hypertext links. In this alternative embodiment, the resolution system 240 communicates with a program running on the Web server 112 to request that the program replace the first Web page 114 with the copy of the first Web page 114 that incorporates the recommended solution. This alternative embodiment will rely on the notification system to inform the Web author 150 that the present invention modified the first Web page 114 to correct an inaccurate hypertext link.

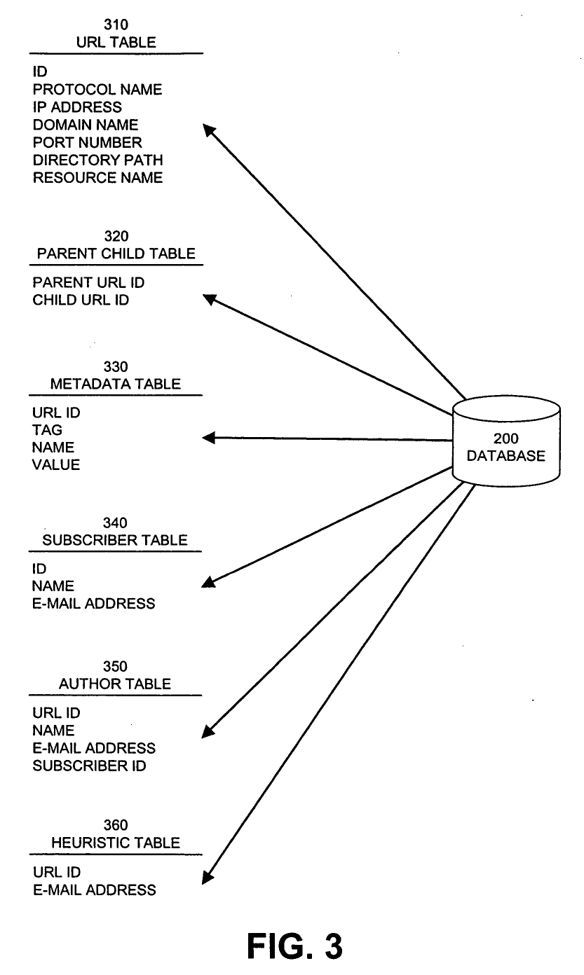

FIG. 3 illustrates the structure for the database 200 of the preferred embodiment for storing the information collected from the Web-crawler 120 and subscriber 140 and processed by the change-detection and notification system 130. The database 200 comprises a URL table 310, parent child table 320, metadata table 330, subscriber table 340, author table 350, and heuristic table 360. The preferred embodiment of the present invention uses database management system software such as the DB2® product by IBM® to create and manage this database.

The URL table 310 includes a record for each Web page that the Web-crawler 120 visits. Each record in the URL table 310 includes a field that uniquely identifies the record. In addition, each record in the URL table 310 includes fields that store the URL protocol scheme (e.g., http, ftp, telnet, file, or mailto), internet protocol address (e.g., 128.183.52.52), domain name (e.g., www.ibm.com), port number (e.g., 80), directory path of the resource (e.g., products), and the resource name (e.g., index.html).

Each record in the parent child table 320 includes two pointers to unique identifiers in the URL table 310. The first pointer identifies the URL of the resource that contains a hypertext link (e.g., the first Web page 114) and the second pointer identifies the URL of the resource to which the hypertext link refers (e.g., the second Web page 116). For example, if a Web site home page (i.e., the parent URL) contains three hypertext links to other Web pages (i.e., child URLs) on the Web site, the parent child table 320 will contain three records, each with the same parent URL identifier, but different child URL identifiers.

Metadata is data that describes other data, including summary data and data that describes specific attributes in the other data set. The metadata table 330 includes a record for each “metadata tag” tag (e.g., HTML tags such as “<A>”, “<BASE>”, “<TITLE>”, and “<LINK>”) that the Web-crawler 120 retrieves during the crawl of the Internet 100. Each record in the metadata table 330 includes a pointer to a unique identifier in the URL table 310. In addition, each record in the metadata table 330 contains fields that store the metadata and the name-value pair that a Web page author can define using the HTML “<META>” tag. Web page metadata may also include an indication that a Web page is calling a JavaScript, Java applet, Java servlet, or common gateway interface (“CGI”) program.

The subscriber table 340 includes a record for each subscriber 140. Each record in the subscriber table 340 includes a field that uniquely identifies the record. In addition, each record in the subscriber table 340 includes fields that store the name and electronic mail address for the subscriber 140.

The author table 350 includes a record for each Web author 150. The subscriber 140, either through the user interface or a bulk data load, identifies the URL, as well as the name and electronic mail address of the Web author 150 responsible for maintaining the URL. Each record in the author table 350 includes a pointer to a unique record in the URL table 310 and a pointer to a unique record in the subscriber table 340. In addition, each record in the author table 350 contains fields that store the name and electronic mail address of the Web author 150. If a subscriber is responsible for more than one URL, the author table 350 will contain one record for each URL.

The heuristic table 350 includes a record for each URL processed through the heuristic algorithms. Each record in the heuristic table 350 includes a pointer to a unique identifier in the URL table 310. In addition, each record in the heuristic table 350 contains a field that stores the electronic mail address that the heuristic algorithms determine is likely to reach a person responsible for managing the Web site 110 that hosts the URL.

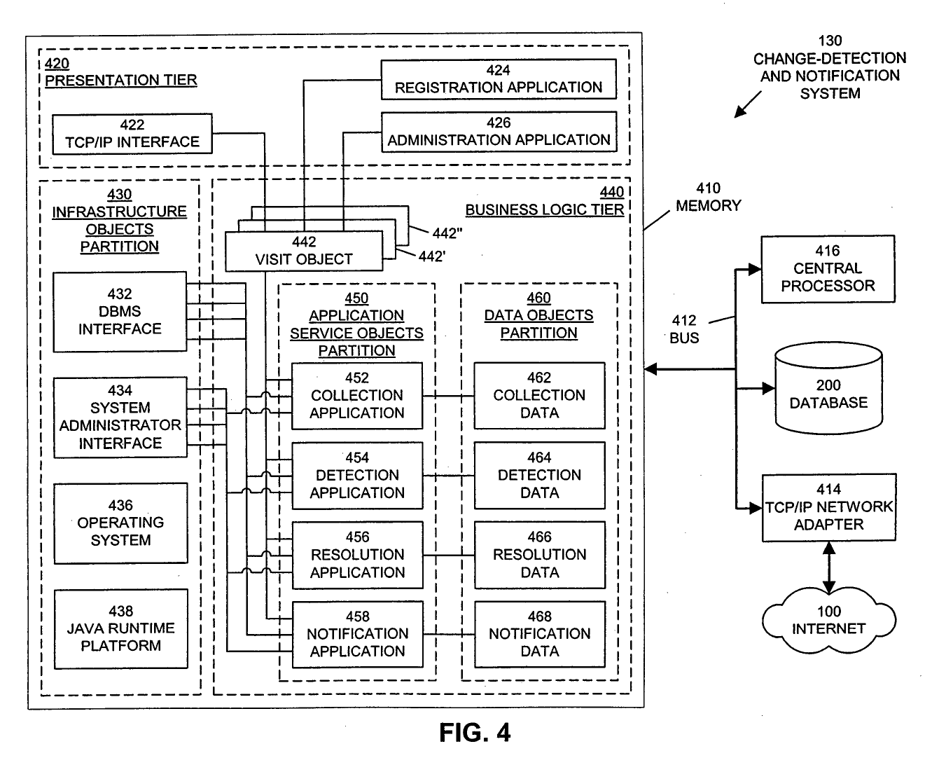

FIG. 4 is a functional block diagram of the change-detection and notification system 130. FIG. 4 depicts the memory 410 of the change-detection and notification system 130 storing components of software program objects that collect metadata, detect an erroneous hypertext link in a first Web page 114, determines solutions that will remedy the erroneous link, and notify the Web author 150 of the solutions. The system bus 412 also connects the memory 410 of change-detection and notification system 130 to the transmission control protocol/internet protocol (“TCP/IP”) network adapter 414, database 200, and central processor 416. The TCP/IP network adapter 414 facilitates the passage of network traffic between the change-detection and notification system 130 and the Internet 100. The central processor 416 executes the programmed instructions stored in the memory 410.

FIG. 4 shows the functional modules of the change-detection and notification system 130 arranged as an object model. The object model groups object-oriented software programs into components that perform the major functions and applications in the change-detection and notification system 130. A suitable implementation of the object-oriented software program components of FIG. 4 may use the Enterprise JavaBeans specification. The book by Paul J. Perrone et al., entitled “Building Java Enterprise Systems with J2EE” (Sams Publishing, June 2000) provides a description of a Java enterprise application developed using the Enterprise JavaBeans specification. The book by Matthew Reynolds, entitled “Beginning E-Commerce” (Wrox Press Inc., 2000) provides a description of the use of an object model in the design of a Web server for an Electronic Commerce application.

The object model for the memory 410 of the change-detection and notification system 130 employs a three-tier architecture that includes the presentation tier 420, infrastructure objects partition 430, and business logic tier 440. The object model further divides the business logic tier 440 into two partitions, the application service objects partition 450 and data objects partition 460.

The presentation tier 420 retains the programs that manage the interactions between a subscriber 140 or operator 270 and the change-detection and notification system 130. In FIG. 4, the presentation tier 420 includes the TCP/IP interface 422, registration application 424, and administration application 426. A suitable implementation of the presentation tier 420 may use Java servlets to interact with a subscriber 140 to the present invention via the hypertext transfer protocol (“HTTP”). The Java servlets run within a request/response server that handles request messages from the subscriber 140 or operator 270 and returns response messages to the subscriber 140 or operator 270. A Java servlet is a Java program that runs within a Web server environment. A Java servlet takes a request as input, parses the data, performs logic operations, and issues a response back to the subscriber 140 or operator 270. The Java runtime platform pools the Java servlets to simultaneously service many requests. A TCP/IP interface 422 functions as a Web server because it uses Java servlets and the HTTP protocol to communicate with the subscriber 140 or operator 270. The TCP/IP interface 422 accepts HTTP requests from the subscriber 140 or operator 270 and passes the information in the request to the visit object 442 in the business logic tier 440. Visit object 442 passes result information returned from the business logic tier 440 to the TCP/IP interface 422. The TCP/IP interface 422 sends these results back to the subscriber 140 or operator 270 in an HTTP response. The TCP/IP interface 422 uses the TCP/IP network adapter 414 to exchange data via the Internet 100.

The infrastructure objects partition 430 retains the programs that perform administrative and system functions on behalf of the business logic tier 440. The infrastructure objects partition 430 includes the operating system 436, and an object oriented software program component for the database management system (“DBMS”) interface 432, system administrator interface 434, and Java runtime platform 438.

The business logic tier 440 retains the programs that perform the substance of the present invention. The business logic tier 440 in FIG. 4 includes multiple instances of the visit object 442. A separate instance of the visit object 442 exists for each client session initiated by the registration application 424, administration application 426, or Web-crawler 120 via the TCP/IP interface 422. Each visit object 442 is a stateful session bean that includes a persistent storage area which is active during the entire client session, not just during a single invocation or method call. The persistent storage area retains information associated with either a Web page, such as the first Web page 114 or second Web page 116, subscriber 140, or operator 270. In addition, the persistent storage area retains data exchanged between the change-detection and notification system 130 and the Web-crawler 120 via the TCP/IP interface 422 such as the query result sets from a database 200 query.

When the Web-crawler 120 gleans information about a Web page, a message sent to the TCP/IP interface 422 invokes a method to create a visit object 442 and stores intermediary results in the visit object 442 state. The visit object 442, in turn, invokes a method in the collection application 452 to process the metadata gleaned by the Web-crawler 120 and store the information in the database 200. The collection application 452 stores intermediary results in the collection data 462 state prior to storing the metadata in the database 200. The detection application 454 periodically examines the database 200 to search for inaccessible or erroneous hypertext links in the metadata gleaned by the Web-crawler 120 and stores intermediary results in the detection data 464 state. If a hypertext link is inaccessible or erroneous, the detection application 454 invokes a method in the resolution application 456 to determine why the hypertext link is not accessible. The resolution application 456 stores intermediary results in the resolution data 466 state from the database 200 queries necessary to develop a list of possible solutions, a recommended solution, and a copy of the URL that includes the hypertext link after applying the recommended solution. The resolution application 456, in turn, invokes a method in the notification application 458 to send an electronic mail message to the author of the URL that contains the information determined by the resolution application 456. The notification application 458 stores intermediary results in the notification data 468 state resulting from querying the database 200 or applying heuristic algorithms to determine the author of the URL.

FIG. 4 depicts the change-detection and notification system 130 as a single general-purpose computer with central processor 416 controlling the collection application 452, detection application 454, resolution application 456, and notification application 458. A person skilled in the art will realize, however, that the processing performed by each of these applications can be distributed to separate general-purpose computers configured similarly to the change-detection and notification system 130.

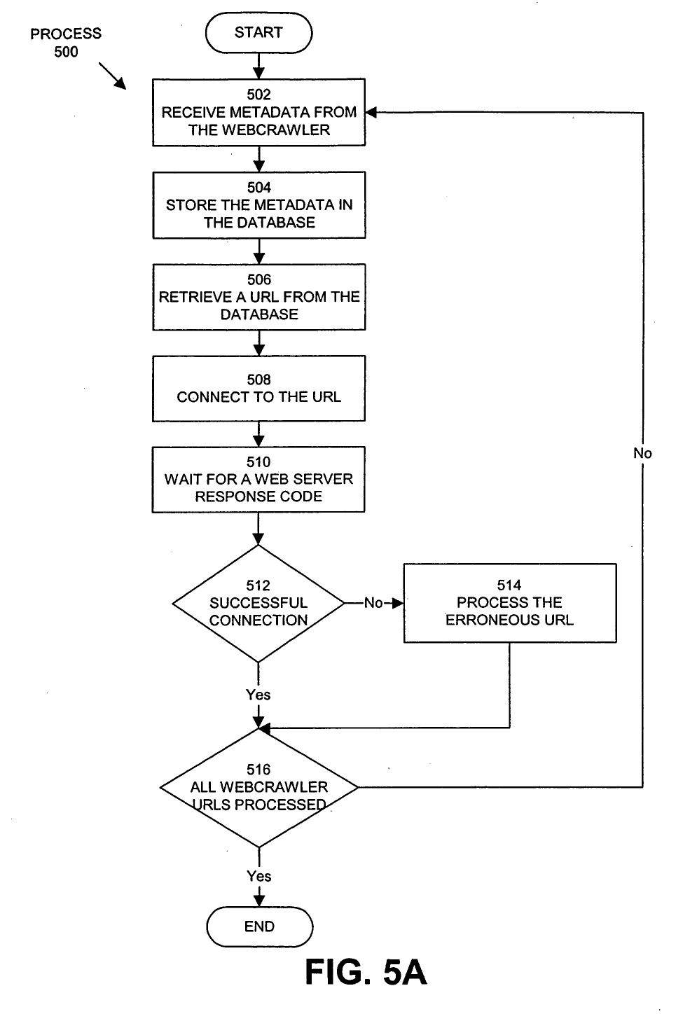

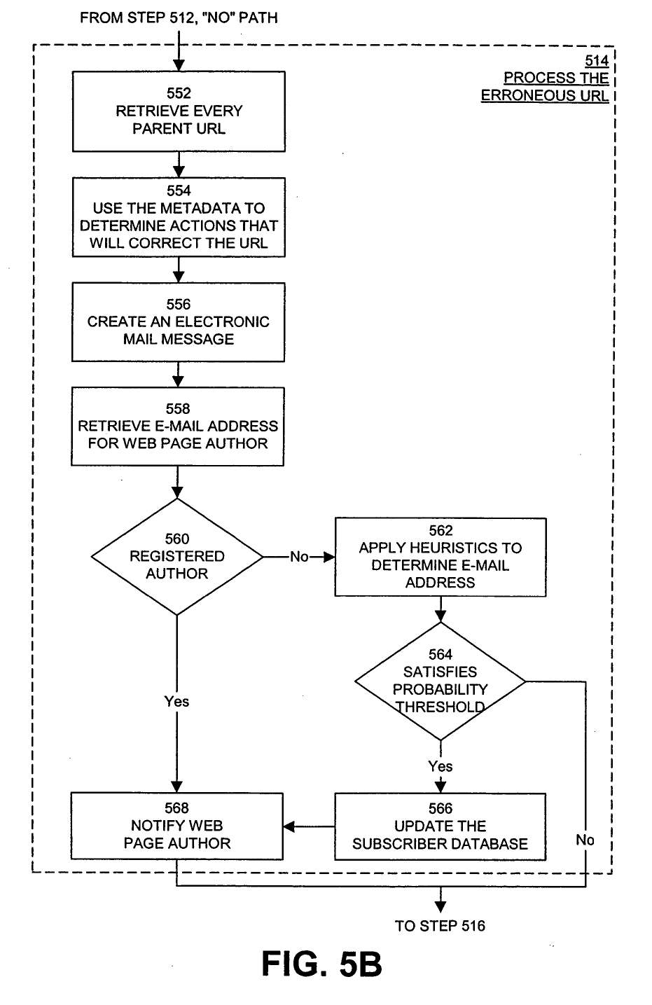

FIG. 5A is a flow diagram that describes the processing that the collection application 452 and detection application 454 performs for each Web page that the Web-crawler 120 retrieves. FIG. 5B is a flow diagram that describes the processing that the resolution application 456 and notification application 458 performs for each Web page that contains an inaccurate or erroneous hypertext link.

A subscriber 140 accessing the registration system 210 user interface causes the registration application 424 to invoke a method to create a visit object 442 and stores the intermediary data collected from the subscriber 140 in the visit object 442 state. The registration application 424 accepts input from the subscriber 140 and stores the registration data in the database 200. An operator 270, accessing the administration system 260 user interface, causes the administration application 426 to invoke a method to create a visit object 442 and store the intermediary data collected in the visit object 442 state. The administration application 426 is the mechanism that the operator 270 uses to maintain the present invention and retrieve health and status data. FIG. 4 depicts the change-detection and notification system 130 as a single general-purpose computer with central processor 416 controlling the registration application 424 and administration application 426. A person skilled in the art will realize, however, that the functions performed by these applications can be distributed to a separate general-purpose computer configured similarly to the change-detection and notification system 130.

FIG. 5A is a flow diagram of a process 500 in the change-detection and notification system 130 that periodically examines hypertext links in each Web page on the Internet 100. The process 500, at step 502, receives metadata from the Web-crawler 120. Step 504 stores the metadata in the database 200. Step 506 examines the database 200 to retrieve the target URL associated with a hypertext link in the metadata. Step 508 initiates a network connection to the URL from step 506 by sending a request through the Internet 100 to a Web server 112 to connect to a Web page, such as second Web page 116. Following the connection request in step 508, step 510 waits for a response code from the Web server 112. At step 512, process 500 examines the status of the request to connect to the URL from step 506. In the preferred embodiment, the response codes that the process 500 recognizes include the HTTP response codes. If step 512 determines that the connection to the URL from step 506 was successful, process 500 proceeds to step 516 to determine whether Web-crawler 120 has identified more URLs that process 500 needs to analyze. In the preferred embodiment, the HTTP response code “200 Message Follows (Success)” indicates that the connection was successful. If step 516 determines that there are more URLs to process, process 400 repeats from step 502, otherwise, process 500 terminates. If step 512 determines that the connection to the URL from step 506 was not successful, process 500 performs step 514 to process the erroneous URL before proceeding to step 516. In the preferred embodiment, the HTTP response codes “301 Moved Permanently”, “403 Forbidden”, “404 Not Found”, or “500 Server Error” indicate that the connection was not successful. FIG. 5B describes step 514 in greater detail. Even though the preferred embodiment uses the HTTP communication protocol and response codes, the present invention contemplates any and all such communication protocols and response codes.

FIG. 5B is a flow diagram that describes step 514 in greater detail. Step 552 queries the database 200 to retrieve every parent URL (i.e., every Web page such as first Web page 114 that contains a hypertext link to the URL from step 506) associated with the URL determined to be erroneous in step 512. Step 554 determines the actions that may correct the erroneous URL by querying the database 200 to retrieve the URL data and metadata. Step 556 uses the information obtained in step 554 to create the body of an electronic mail message that comprises a description of the actions that may correct the erroneous URL, a recommended action, and an attachment that contains the URL after applying the recommended action. In addition, the change-detection and notification system 130 may have the ability to download, copy, and repair the parent URL.

For each parent URL retrieved in step 552, step 558 queries the database 200 for the electronic mail address of the Web author 150 associated with the URL. If the database query in step 558 returns explicit contact information, step 560 determines if the Web author 150 is registered with the present invention. If the answer at step 560 is “Yes”, process 500 can proceed to step 568 to notify the Web author 150 by sending the electronic mail message. If the database query in step 558 does not return explicit contact information, the answer at step 560 is “No” and process 500 proceeds to step 562 to apply heuristic algorithms to deduce the electronic mail address of the Web author 150. Step 562 may apply several heuristic algorithms (i.e., a method of problem solving that uses exploration and trial and error) to determine the electronic mail address of the Web author 150 of a specific URL. One heuristic algorithm employed by the present invention is described in greater detail in the pending U.S. patent application Ser. No.______, filed______, entitled “______”, assigned to IBM® and incorporated herein by reference.

Step 562 uses heuristic criteria based on a lexical and structural analysis of metadata from a set of known webmaster “mailto” links within a set of known Web sites. A “mailto” link is similar to a hypertext link, however, instead of taking you to a new Web page, the “mailto” link opens the default electronic mail program with a new, pre-addressed message. The person clicking on the “mailto” link types and sends an electronic mail message to provide feedback on the Web page. For each electronic mail address that is not associated with a Web author 150, step 562 queries the database 200 to retrieve the “mailto” links associated with a parent URL, such as first Web page 114. Analysis of the “mailto” links allows the change-detection and notification system 130 to determine the probability that a specific “mailto” link will successfully contact the Web author 150 or a person responsible for managing the Web site that hosts the parent URL.

In the preferred embodiment, the heuristic algorithms of step 562 search the database 200 for explicit contact information associating the Web author 150 with a specific URL. Examples of explicit contact information include an electronic mail address:

1. Associated with a Web author 150 registered with the present invention;

2. Embedded in a Web page that includes the introductory string “webmaster@”; and

3. Identified previously by the heuristic algorithm of step 562 and stored in the database 200.

If the database query in step 558 does not return explicit contact information for the Web author 150, step 562 performs a probabilistic analysis of the parent URL by examining each “mailto” link from every Web page in the Web site associated with those pages. The change-detection and notification system 130 bases this strategy on the probability that the Web author 150 of a specific URL is the same as the Web author 150 for other URLs in the same Web site. The change-detection and notification system 130 determines the electronic mail address for the Web author 150 by clustering the URLs by the Web site hostname, assigning a rank to each electronic mail address in the cluster, and comparing the rank to a predefined probability threshold for the system. For example, the change-detection and notification system.130 may retrieves from the database 200 each “mailto” link in a given cluster of URLs. The system then performs a lexical and structural analysis of the cluster by examining the HTML annotations associated with each “mailto” link, as well as the location of the “mailto” link in the Web page. The system computes a probability score by comparing the result of the lexical and structural analysis to the metadata of a sample set. The probability factors that the change-detection and notification system 130 may use in this analysis include:

1. The frequency of occurrence of words and phrases in the anchor text of the hypertext link (e.g., “mailto:webmaster@”, etc.);

2. The frequency of occurrence of words and phrases in the text surrounding the anchor text of the hypertext link (e.g., “Maintained by”, etc.);

3. The frequency of occurrence of words and phrases in the HTML title, description ,or keyword metadata of the Web page containing the “mailto:webmaster@” link; and

4. The distribution (e.g., hierarchical depth from the “home” page) of the Web pages in the Web site that contain the “mailto:webmaster@” link.

After associating a probability with each “mailto” link, step 562 chooses the link or electronic mail address that has the highest probability. In step 564, if the score exceeds a predetermined threshold value, the system deduces that the hypertext link is likely to contact someone who is either the author of the Web page or a person responsible for managing the Web site that hosts the Web page. Step 566 updates the database 200 to associate the highest probability address with the URL from step 506. If the score at step 564 does not exceed the predetermined threshold, the system does not take any action and proceeds to step 516 to continue processing URLs received from the Web-crawler 120.

The heuristic algorithms described above could complement the analysis by using additional criteria and more refined probabilistic analysis. This disclosure contemplates the use of additional criteria and more refined probabilistic analysis in the heuristic algorithms.

Although embodiments disclosed in the present invention describe a fully functioning system, it is to be understood that other embodiments exist that are equivalent to the embodiments disclosed herein. Since numerous modifications and variations will occur to those who review the instant application, the present invention is not limited to the exact construction and operation illustrated and described herein. Accordingly, all suitable modifications and equivalents that may be resorted to are intended to fall within the scope of the claims.

We claim:

1. A system for managing digital resources on a network, the network connects to at least one network site having at least one network server to access a first digital resource and a second digital resource, the first digital resource having a link to the second digital resource, the system comprising:
a change-detection system connected to the network, wherein the change-detection system examines the first digital resource and the second digital resource to detect an error in the link to the second digital resource; and
a notification system that communicates a message describing the error to an author of the first digital resource.

2. The system of claim 1 further comprising:
a registration system connected to the network, the registration system having an interface for a subscriber to create an association in a database between the author and the first digital resource.

3. The system of claim 2, wherein the notification system further comprises:
a first notification subsystem that submits a query to the database to retrieve the author of the first digital resource; and
a second notification subsystem that determines the author of the first digital resource if the query by the first notification subsystem fails to retrieve the author of the first digital resource.

4. The system of claim 3, wherein the second notification subsystem determines the author of the first digital resource by applying heuristic algorithms and performing a probabilistic analysis.

5. The system of claim 1 further comprising:
an administrative system having an interface for an operator to maintain the system.

6. The system of claim 1, wherein the change-detection system further comprises:
a collection system connected to the network, wherein the collection system retrieves data from said at least one network site and stores the data in a database; and
a detection system that examines the first digital resource and the second digital resource to detect an error in the link to the second digital resource.
Web-crawler that retrieves data from said at least one network site.

7. The system of claim 6, wherein the collection system includes a Web-crawler that retrieves data from said at least one network site.

8. The system of claim 1, wherein the notification system includes a resolution system that generates the message describing the error in the link to the second digital resource.

9. The system of claim 1, wherein the message includes at least one resolution for the error.

10. The system of claim 9, wherein the message further includes a recommended resolution for the error.

11. The system of claim 10, wherein the message further includes a modified first digital resource comprising a copy of the first digital resource altered by application of the recommended resolution for the error.

12. The system of claim 11, wherein the notification system further communicates a request to said at least one network server to replace the first digital resource with the modified digital resource.

13. The system of claim 12, wherein the message includes an indication that the notification system replaced the first digital resource with the modified first digital resource.

14. A method for managing digital resources on a network, the network connects to at least one network site having at least one network server to access a first digital resource and a second digital resource, the first digital resource having a link to the second digital resource, the method comprising the steps of:
creating an association in a database between an author and the first digital resource;
retrieving data from said at least one network site;
storing the data in the database;
examining the first digital resource and the second digital resource to detect an error in the link to the second digital resource;
generating a message describing the error; and
communicating the message to the author of the first digital resource.

15. The method of claim 14, the message including at least one resolution for the disparate content.

16. The method of claim 15, the message further including a recommended resolution for the disparate content.

17. The method of claim 16, the message further including a modified first digital resource comprising a copy of the first digital resource altered by application of the recommended resolution.

18. The method of claim 17, wherein the communicating step further comprises:
transmitting a request to said at least one network server to replace the first digital resource with the modified first digital resource.

19. The method of claim 18, the message further including an indication that said at least one network server replaced the first digital resource with the modified first digital resource.

20. The method of claim 14, wherein the generating step further comprises:
querying the database for the author of the first digital resource.

21. The method of claim 20, wherein if the querying step fails to retrieve the author of the first digital resource, the generating step further comprises:
applying heuristic algorithms; and
performing a probabilistic analysis.

22. Computer executable software code stored on a computer readable medium, the code for managing digital resources on a network, the network connects to at least one network site having at least one network server to access a first digital resource and a second digital resource, the first digital resource having a link to the second digital resource, the code comprising:
code to create an association in a database between an author and the first digital resource;
code to detect a change in the first digital resource; and
code to notify the author of the change in the first digital resource.

23. The computer executable software code of claim 22, wherein the code to detect a change further comprises:
code to retrieve data from said at least one network site and store the data in the database; and
code to examine the first digital resource and the second digital resource to detect an error in the link to the second digital resource.

24. The computer executable software code of claim 23, wherein the code to notify the author further comprises:
code to generate a message describing a resolution for the error; and
code to communicate the message to the author of the first digital resource.

25. The computer executable software code of claim 24, wherein the code to communicate the message further comprises:
code to query the database for the author of the first digital resource; and
code to determine the author of the first digital resource by applying heuristic algorithms and performing a probabilistic analysis if the code to query the database does not retrieve the author of the first digital resource.

26. The computer executable software code of claim 22 further comprising:
code to maintain the database and software processes.
